(19) United States
(12) Patent Application Publication
(10) Pub. No.: US 2009/0312175 A1
(43) Pub. Date: Dec. 17, 2009

(54) Increased Activity of Catalyst Using Inorganic Acids

(75) Inventors: H. Russell Kunz, Vernon, CT (US); Leonard J. Bonville, Marlborough, CT (US); Richard S. Parnas, Winchester, MA (US); Robert Paul Brooker, Rockledge, FL (US); Beth Cheney, New Hartford, CT (US); Phillip Baker, Groton, CT (US)

Correspondence Address: MCCARTER & ENGLISH, LLP STAMFORD, FINANCIAL CENTRE , SUITE 304A, 695 EAST MAIN STREET, STAMFORD, CT, 06901-2138, US

(73) Assignee: UNIVERSITY OF CONNECTICUT, Farmington, CT (US)

(21) Appl. No.: 12/432,090

(22) Filed: Apr. 29, 2009

Related U.S. Application Data
(60) Provisional application No. 61/048,748, filed on Apr. 29, 2008.

(51) Int. Cl. B01J 37/30

(52) U.S. Cl. 502/11

(57) ABSTRACT

The present disclosure provides for improved electrochemical devices (e.g., fuel cells, metal air batteries, ultra capacitors, etc.) and components therefore. More particularly, the present disclosure provides for improved systems and methods for producing materials, membranes, electrode assemblies (e.g., membrane electrode assemblies) and electrochemical devices employing the membranes and/or electrode assemblies. The present disclosure provides for improved systems and methods for producing high activity materials, membranes and/or electrode assemblies (e.g., MEAs) for use in electrochemical devices, wherein the high activity membranes and/or electrode assemblies include at least one inorganic acid. In exemplary embodiments, the present disclosure provides for improved systems and methods for producing high activity membranes and/or electrode assemblies (e.g., MEAs) for use in electrochemical devices, wherein the high activity membranes and/or electrode assemblies include at least one inorganic acid in the catalyst layer and/or in the cathode.

### CROSS-REFERENCE TO RELATED APPLICATIONS

This application claims the benefit of U.S. Provisional Application No. 61/048,748 filed Apr. 29, 2008, all of which is herein incorporated in its entirety.

### NAMES OF PARTIES TO A JOINT RESEARCH AGREEMENT

The work described in this patent disclosure was supported by the University Central Florida under Grant/Contract No. 105759.

### BACKGROUND

1. Technical Field

The present disclosure relates to electrochemical devices (e.g., fuel cells, metal air batteries, ultra capacitors, etc.) and components therefore, and, more particularly, to systems and methods for producing materials, membranes, electrode assemblies (e.g., membrane electrode assemblies) and/or electrochemical devices employing the membranes and/or electrode assemblies.

2. Background Art

In general, electrochemical devices, such as, for example, fuel cells, metal air batteries, and ultra capacitors are similar electrochemical devices that generate and/or store electrical energy. Fuel cells are typically different from batteries in that they generally consume reactant from an external source, which must be replenished. Thus, fuel cells are typically a thermodynamically open system. By contrast, batteries typically store electrical energy chemically and hence generally represent a thermodynamically closed system.

Generally, a fuel cell is an electrochemical energy conversion device. Fuel cells typically produce electricity from fuel on the anode side and an oxidant on the cathode side. In general, the reactants flow into the cell, and react in the presence of an electrolyte. The reaction products typically flow out of it, while the electrolyte generally remains within it. In general, fuel cells can operate virtually continuously as long as the necessary flows are maintained, and the thermal balance is maintained.

Similarly, metal-air cells (e.g., metal air batteries) typically include a carbon air gas diffusion electrode and a metal anode. In general, metal-air cells have low self-discharge and typically operate at high current densities. The mechanism of gas-transport in the hydrophobic gas layer, and the various carbon-based catalysts for the electrochemical oxygen reduction reaction at the cathode typically utilize similar technologies as used in fuel cells. Methods for diagnosing the activity and transport properties of the catalysts are also typically similar. In general, one difference between fuel cells and metal air batteries is that the metal anode of the metal air battery is typically electrochemically consumed.

In general, ultra capacitors or double-layer capacitors typically polarize an electrolytic solution to store energy electrostatically. Though an ultra capacitors or double-layer capacitor is an electrochemical device, typically no chemical reactions are involved in its energy storage mechanism. This mechanism is highly reversible, and generally allows the ultra capacitor to be charged and discharged hundreds of thousands of times.

Some ultra capacitors include two non-reactive porous plates, or collectors, suspended within an electrolyte, with a voltage potential applied across the collectors. In general, in an individual ultra capacitor cell, the applied potential on the positive electrode attracts the negative ions in the electrolyte, while the potential on the negative electrode attracts the positive ions. Typically, a dielectric separator between the two electrodes prevents the charge from moving between the two electrodes.

In general, fuel cells are electrochemical cells in which a free energy change resulting from a fuel oxidation reaction is converted into electrical energy. Fuel cells are attractive electrical power sources, due to their higher energy efficiency and environmental compatibility compared to the internal combustion engine, for example. Some of the known fuel cells are those using a gaseous fuel (such as hydrogen) with a gaseous oxidant (usually pure oxygen or atmospheric oxygen), and those fuel cells using direct feed organic fuels such as methanol. In contrast to batteries, which generally must be recharged, electrical energy from fuel cells may be produced for as long as the fuels, e.g., methanol or hydrogen, and oxidant, are supplied. Thus, an interest exists in the design of improved fuel cells to fill future energy needs.

One type of electrochemical cell that has been employed in the manufacture of fuel cells is the ion exchange membrane (“IEM”) cell. In general, an IEM cell typically employs a membrane that includes an ion-exchange polymer. Typically, this ion-exchange polymer membrane serves as a physical separator between the anode and cathode, while also serving as an electrolyte. For example, IEM cells may be operated as electrolytic cells for the production of electrochemical products, or operated as fuel cells for the production of electrical energy.

For example, in some IEM cells, a cation exchange membrane may be used wherein protons are transported across the membrane as the cell is operated. Such cells are sometimes referred to as proton exchange membrane (“PEM”) cells. In general, PEM fuel cells operate by employing a proton exchange membrane to separate a hydrogen oxidation reaction (“HOR”) at the anode from an oxygen reduction reaction (“ORR”). For example, in a cell employing the hydrogen/oxygen couple, hydrogen molecules (fuel) at the anode are oxidized donating electrons to the anode, while at the cathode the oxygen (oxidant) is reduced accepting electrons from the cathode. Typically, the H⁺ ions (protons) formed at the anode migrate through the membrane to the cathode and combine with oxygen to form water. In some fuel cells, the anode and/or cathode includes a layer of electrically conductive, catalytically active particles (typically in a polymeric binder) on the PEM. The resulting structure (sometimes also including current collectors) is generally referred to as a membrane electrode assembly (“MEA”).

In general, PEMs also require effective catalysts associated with the membranes to provide for reactivity with the fuel and oxidant sources, and resulting products of catalysis. Typically, a catalyst layer is applied to the membrane using, for example, a combination of temperature, pressure, and perhaps an adhesive. For example, such layered structure may be placed between two porous substrates. For example, some current catalysts using various alloys of platinum, ruthenium and/or other precious metals are employed (e.g., in an attempt to improve activity at high temperature and low relative humidity). However, creating alloys can require complicated reaction mechanisms, with expensive precursor molecules, or may necessitate highly specific equipment.

Proton exchange membrane fuel cells (PEMFCs) have the potential to decrease the consumption of fuels for electrical energy production and the generation of greenhouse gases. One of the difficulties with these fuel cells is their relatively high cost that is partially related to the cost of the catalyst (e.g., various alloys of platinum, ruthenium and/or other precious metals) needed to catalyze the reaction at the cell cathode. Thus, despite efforts to date, a need remains for cost-effective, yet efficient catalysts for use in PEMFCs. More particularly, a need remains for cost-effective, yet efficient cathode catalysts that are associated with the membranes in PEMFCs.

In one approach to the construction of an ion exchange membrane, perfluorinated sulfonic acid polymers such as Nafion® (and other ion exchange materials) may be incorporated into films, for example porous polytetrafluoroethylene (PTFE), to form composite membranes; as described for example in U.S. Pat. No. 5,082,472, to Mallouk, et al.; JP Laid-Open Pat. Application Nos. 62-240627, 62-280230 and 62-280231; U.S. Pat. No. 5,094,895 to Branca, U.S. Pat. No. 5,183,545 to Branca et al.; and U.S. Pat. No. 5,547,551 to Bahar, et al. In addition, U.S. Pat. No. 6,465,136 to Fenton et al. and U.S. Pat. No. 6,638,659 to Fenton et al. also disclose systems and/or methods for fabricating composite membranes. Each of the foregoing references is incorporated herein in their entirety.

One group of ion-exchange materials for PEM cells is perfluorinated sulfonic acid polymers such as, for example, Nafion®. In general, such ion-exchange polymers have good conductivity and chemical and thermal resistance, which provide long service life before replacement. However, increased proton conductivity is desired for some applications, particularly for fuel cells, which operate at high current densities.

Some advantages, such as, for example, more efficient heat rejection, improved impurities tolerance and more useful waste heat, result by operating a PEMFC at elevated temperatures (e.g., above about 100° C.). For example, operation of Nafion®-based polymer electrolyte membrane fuel cells (“PEFCs”) at elevated temperature is typically limited by the electrolyte's dependence on water content. In general, proton conductivity of Nafion® decreases with relative humidity. Therefore, operating a fuel cell above the boiling point of water generally necessitates either pressurized operation at high relative humidities (RHs), or lower RH operation at atmospheric pressure. In addition, studies have shown that the kinetics of the oxygen reduction reaction (“ORR”) decrease below relative humidities of about 60-70%, presumably due to decreased proton activity (See, e.g., H. Xu, Y. Song, H. R. Kunz, and J. M. Fenton, Journal of the Electrochemical Society, 152, A1828-A1836 (2005)).

Some approaches have been adopted to extend the operating temperature of the PEM from the 60 to 80° C. operating range, to temperatures around about 120° C. In general, these studies have been conducted under fully saturated environments, typically necessitating elevated operating pressures at temperatures above 100° C. In general, from a systems viewpoint, for example, operation close to atmospheric pressure is desired to avoid work associated with air compression. Therefore, despite efforts to date, a need remains for electrochemical cells (e.g., fuel cells and/or PEMs or the like) that are functional and/or exhibit operational improvement at the higher temperature (e.g., about 118° C.), low RH (e.g., about 40% RH), and atmospheric pressure environment. These and other inefficiencies and opportunities for improvement are addressed and/or overcome by the systems and methods of the present disclosure.

### SUMMARY

The present disclosure provides for advantageous electrochemical devices (e.g., fuel cells, metal air batteries, ultra capacitors, etc.) and components therefore, and, more particularly, to systems and methods for producing materials, membranes, electrode assemblies (e.g., membrane electrode assemblies) and/or electrochemical devices employing the membranes and/or electrode assemblies.

In general, the present disclosure provides for improved systems and methods for producing high activity materials, membranes and/or electrode assemblies (e.g., membrane electrode assemblies or “MEAs”) for use in electrochemical devices (e.g., fuel cells, etc.), wherein the high activity membranes and/or electrode assemblies include at least one inorganic acid. In exemplary embodiments, the present disclosure provides for improved systems and methods for producing high activity membranes and/or electrode assemblies (e.g., membrane electrode assemblies) for use in electrochemical devices, wherein the high activity membranes and/or electrode assemblies include at least one inorganic acid in the catalyst layer and/or in the cathode. In one embodiment, the inorganic acid is a solid inorganic acid, such as, for example, a heteropolyacid.

The present disclosure provides for a method for fabricating an electrode assembly including: a) soaking a cathode catalyst in an inorganic acid; b) drying the cathode catalyst after soaking; c) mixing the cathode catalyst with an ion-exchange material to form a cathode catalyst mixture; d) applying the cathode catalyst mixture on a membrane or material layer. The present disclosure also provides for a method for fabricating an electrode assembly wherein the cathode catalyst is a platinum on carbon cathode catalyst. The present disclosure provides for a method for fabricating an electrode assembly wherein the cathode catalyst is about 46.5 wt % platinum.

The present disclosure also provides for a method for fabricating an electrode assembly wherein the inorganic acid is a heteropolyacid. The present disclosure also provides for a method for fabricating an electrode assembly wherein the inorganic acid is selected from the group consisting of silicotungstic acid (STA), phosphotungstic acid (PTA), tungstomolybdic acid, zirconium hydrogen phosphate, phosphomolybdic acid (PMA) and combinations thereof.

The present disclosure also provides for a method for fabricating an electrode assembly wherein the ion-exchange material is a polymer electrolyte. The present disclosure also provides for a method for fabricating an electrode assembly wherein the ion-exchange material is a perfluorinated sulfonic acid polymer or sulfonated polyetherether ketone polymer. The present disclosure also provides for a method for fabricating an electrode assembly wherein step a) is performed by soaking the cathode catalyst in about a 10 wt % solution of inorganic acid. The present disclosure also provides for a method for fabricating an electrode assembly wherein the inorganic acid is a heteropolyacid.

The present disclosure also provides for a method for fabricating an electrode assembly wherein step b) is performed by drying the cathode catalyst at about 140° C. for about one hour. The present disclosure also provides for a method for fabricating an electrode assembly wherein step c) further comprises mixing water and methanol with the cathode catalyst and the ion-exchange material to form the cathode catalyst mixture. The present disclosure also provides for a method for fabricating an electrode assembly wherein the catalyst mixture of step c) is homogenized with a homogenizer prior to step d). The present disclosure also provides for a method for fabricating an electrode assembly wherein the cathode catalyst mixture is applied on the membrane or material layer by spraying, screen printing, or by forming a cathode catalyst mixture decal that is transferred to the membrane or material layer. The present disclosure also provides for a method for fabricating an electrode assembly wherein the membrane or material layer is a proton exchange membrane.

The present disclosure also provides for a method for fabricating an electrode assembly further including the steps of: e) converting the ion-exchange material and inorganic acid to cesium form; f) hot-pressing the membrane or material layer; and g) protonating the membrane or material layer to convert the ion-exchange material and inorganic acid to acid form; wherein steps e), f), and g) are performed after step d). The present disclosure also provides for a method for fabricating an electrode assembly wherein step e) is performed by soaking the membrane or material layer in cesium carbonate. The present disclosure also provides for a method for fabricating an electrode assembly wherein step f) is performed by hot-pressing the membrane or material layer at about 180° C. and about 20 psi pressure. The present disclosure also provides for a method for fabricating an electrode assembly wherein step g) is performed by soaking the membrane or material layer in sulfuric acid.

The present disclosure also provides for a method for fabricating an electrode assembly wherein the ion-exchange material has an equivalent weight of about 600 to about 1000, and wherein the membrane or material layer has an equivalent weight of about 850 to about 1200.

The present disclosure also provides for a method for fabricating an electrode assembly including: a) mixing a cathode catalyst, an inorganic acid and an ion-exchange material to form a cathode catalyst mixture; and b) applying the cathode catalyst mixture on a membrane or material layer. The present disclosure also provides for a method for fabricating an electrode assembly wherein the cathode catalyst is a platinum on carbon cathode catalyst. The present disclosure also provides for a method for fabricating an electrode assembly wherein the cathode catalyst is about 46.5 wt % platinum.

The present disclosure also provides for a method for fabricating an electrode assembly wherein the inorganic acid is a heteropolyacid. The present disclosure also provides for a method for fabricating an electrode assembly wherein the inorganic acid is selected from the group consisting of silicotungstic acid (STA), phosphotungstic acid (PTA), tungstomolybdic acid, zirconium hydrogen phosphate, phosphomolybdic acid (PMA) and combinations thereof.

The present disclosure also provides for a method for fabricating an electrode assembly wherein the ion-exchange material is a polymer electrolyte. The present disclosure also provides for a method for fabricating an electrode assembly wherein the ion-exchange material is a perfluorinated sulfonic acid polymer or sulfonated polyetherether ketone polymer. The present disclosure also provides for a method for fabricating an electrode assembly wherein the cathode catalyst mixture is applied on the membrane or material layer by spraying, screen printing, or by forming a cathode catalyst mixture decal that is transferred to the membrane or material layer. The present disclosure also provides for a method for fabricating an electrode assembly wherein the membrane or material layer is a proton exchange membrane.

The present disclosure also provides for a method for fabricating an electrode assembly further including the steps of: c) converting the ion-exchange material and inorganic acid to cesium form; d) hot-pressing the membrane or material layer; and e) protonating the membrane or material layer to convert the ion-exchange material and inorganic acid to acid form; wherein steps c), d), and e) are performed after step b). The present disclosure also provides for a method for fabricating an electrode assembly wherein step c) is performed by soaking the membrane or material layer in cesium carbonate.

The present disclosure also provides for a method for fabricating an electrode assembly wherein step d) is performed by hot-pressing the membrane or material layer at about 180° C. and about 20 psi pressure. The disclosure also provides for a method for fabricating an electrode assembly where step e) is performed by soaking the membrane or material layer in sulfuric acid.

The present disclosure also provides for a method for fabricating an electrode assembly wherein the ion-exchange material has an equivalent weight of about 600 to about 1000, and wherein the membrane or material layer has an equivalent weight of about 850 to about 1200.

The present disclosure also provides for a method for fabricating an electrode assembly including: a) supporting a first ion-exchange material and an inorganic acid in a porous polymeric matrix material to form a membrane or material layer; b) applying electrodes to the membrane or material layer; c) converting the first ion-exchange material and inorganic acid to cesium form; d) hot-pressing the membrane or material layer; e) protonating the membrane or material layer to convert the first ion-exchange material and inorganic acid to acid form. The present disclosure also provides for a method for fabricating an electrode assembly wherein the first ion-exchange material is a polymer electrolyte, a perfluorinated sulfonic acid polymer or sulfonated polyetherether ketone polymer.

The present disclosure also provides for a method for fabricating an electrode assembly wherein the inorganic acid is a heteropolyacid. The present disclosure also provides for a method for fabricating an electrode assembly wherein the inorganic acid is selected from the group consisting of silicotungstic acid (STA), phosphotungstic acid (PTA), tungstomolybdic acid, zirconium hydrogen phosphate, phosphomolybdic acid (PMA) and combinations thereof. The present disclosure also provides for a method for fabricating an electrode assembly wherein the porous polymeric matrix material is polytetrafluoroethylene (PTFE). The present disclosure also provides for a method for fabricating an electrode assembly wherein the electrodes are applied to the membrane or material layer by spraying, screen printing, or by forming a decal that is transferred to the membrane or material layer. The present disclosure also provides for a method for fabricating an electrode assembly wherein step c) is performed by soaking the membrane or material layer in cesium carbonate. The present disclosure also provides for a method for fabricating an electrode assembly wherein step d) is performed by hot-pressing the membrane or material layer at about 180° C. and about 20 psi pressure. The present disclosure also provides for a method for fabricating an electrode assembly wherein step e) is performed by soaking the membrane or material layer in sulfuric acid.

The present disclosure also provides for a method for fabricating an electrode assembly wherein the first ion-exchange material has an equivalent weight of about 850 to about 1200, and wherein the electrodes include a second ion-exchange material having an equivalent weight of about 600 to about 1000.

The present disclosure also provides for a method for fabricating an electrode assembly including: a) supporting a first ion-exchange material in a porous polymeric matrix material to form a membrane or material layer; b) applying electrodes to the membrane or material layer; c) soaking the membrane or material layer in an inorganic acid; d) converting the first ion-exchange material and inorganic acid to cesium form; e) hot-pressing the membrane or material layer; f) protonating the membrane or material layer to convert the first ion-exchange material and inorganic acid to acid form. The present disclosure also provides a method for fabricating an electrode assembly wherein the first ion-exchange material is a polymer electrolyte, a perfluorinated sulfonic acid polymer or sulfonated polyetherether ketone polymer.

The present disclosure also provides for a method for fabricating an electrode assembly wherein the inorganic acid is a heteropolyacid. The present disclosure also provides for a method for fabricating an electrode assembly wherein the inorganic acid is selected from the group consisting of silicotungstic acid (STA), phosphotungstic acid (PTA), tungstomolybdic acid, zirconium hydrogen phosphate, phosphomolybdic acid (PMA) and combinations thereof.

The present disclosure also provides for a method for fabricating an electrode assembly wherein the porous polymeric matrix material is polytetrafluoroethylene (PTFE). The present disclosure also provides for a method for fabricating an electrode assembly wherein the electrodes are applied to the membrane or material layer by spraying, screen printing, or by forming a decal that is transferred to the membrane or material layer. The present disclosure also provides for a method for fabricating an electrode assembly wherein step c) is performed by soaking the membrane or material layer in about a 10 wt % solution of inorganic acid. The present disclosure also provides for a method for fabricating an electrode assembly wherein step d) is performed by soaking the membrane or material layer in cesium carbonate. The present disclosure also provides for a method for fabricating an electrode assembly wherein step e) is performed by hot-pressing the membrane or material layer at about 180° C. and about 20 psi pressure. The disclosure also provides for a method for fabricating an electrode assembly wherein step f) is performed by soaking the membrane or material layer in sulfuric acid.

The present disclosure provides for a method for fabricating an electrode assembly wherein the first ion-exchange material has an equivalent weight of about 850 to about 1200, and wherein the electrodes include a second ion-exchange material having an equivalent weight of about 600 to about 1000. Additional advantageous features, functions and applications of the disclosed systems and methods of the present disclosure will be apparent from the description which follows, particularly when read in conjunction with the appended figures.

### BRIEF DESCRIPTION OF THE DRAWINGS

To assist those of ordinary skill in the art in making and using the disclosed systems and methods, reference is made to the appended figures, wherein:

FIG. 1 depicts an Activity Summary of STA Cells at about 78° C. and about 100% RH;

FIG. 2 depicts an Activity Summary of STA Cells at about 118° C. and about 40% RH;

FIG. 3 depicts the Effect of STA on the Ratio of Catalytic Activities at about 118° C. and about 78° C.;

FIG. 4 depicts a Performance Comparison of Cells with and without STA in the Cathode on the Basis of Frontal Area;

FIG. 5 depicts a Performance Comparison of Cells with and without STA in the Cathode on the Basis of Real Pt Surface Area;

FIG. 6 depicts the Effect of Cathode Treatment on Cell Activity at about 118° C. and about 40% RH with H₂O₂, based on area on platinum;

FIG. 7 depicts the Effect of Cathode Treatment on Cell Activity at about 78° C. and about 100% RH with H₂O₂, based on area on platinum;

FIG. 8 depicts cell performance and resistance of STA-Nafion® composite membrane at about 118° C. and about 40% relative humidity; and

FIG. 9 illustrates that cell current, at about 0.2V overpotential using H₂O₂ at about 100 kPa, increases with percent STA at about 118° C. and about 40% relative humidity.

### DETAILED DESCRIPTION

The present disclosure provides for improved electrochemical devices (e.g., fuel cells, metal air batteries, ultra capacitors, etc.) and components therefore. More particularly, the present disclosure provides for improved systems and methods for producing materials, membranes, electrode assemblies (e.g., membrane electrode assemblies) and/or electrochemical devices employing the membranes and/or electrode assemblies.

In general, the present disclosure provides for improved systems and methods for producing high activity materials, membranes and/or electrode assemblies (e.g., membrane electrode assemblies or “MEAs”) for use in electrochemical devices (e.g., fuel cells, metal air batteries, ultra capacitors, etc.), wherein the high activity membranes and/or electrode assemblies include at least one inorganic acid. In one embodiment, the present disclosure provides for improved systems and methods for producing high activity membranes and/or electrode assemblies (e.g., membrane electrode assemblies) for use in electrochemical devices, wherein the high activity membranes and/or electrode assemblies include at least one inorganic acid in the catalyst layer. In an exemplary embodiment, the inorganic acid is a solid inorganic acid, such as, for example, a heteropolyacid. In one embodiment, “activity” means the current at about 0.9V of a fuel cell operating with hydrogen and oxygen as fuel and oxidant sources, respectively, although the present disclosure is not limited thereto.

In exemplary embodiments, the present disclosure provides for improved systems and methods for producing high activity membranes and/or electrode assemblies (e.g., MEAs) for use in electrochemical devices (e.g., fuel cells, etc.), wherein the high activity membranes and/or electrode assemblies include at least one inorganic acid in the cathode catalyst layer and/or in the cathode. For example, the at least one inorganic acid may be selected from the group consisting of silicotungstic acid (STA), phosphotungstic acid (PTA), tungstomolybdic acid, zirconium hydrogen phosphate, phosphomolybdic acid (PMA) and combinations thereof.

In exemplary embodiments, the present disclosure provides for systems and methods for producing high activity membranes and/or electrode assemblies (e.g., MEAs) for use in electrochemical devices, wherein the high activity membranes and/or electrode assemblies include silicotungstic acid (STA). In one embodiment, the present disclosure provides for systems and methods for producing high activity membranes and/or electrode assemblies (e.g., MEAs) for use in electrochemical devices, wherein the high activity membranes and/or electrode assemblies include silicotungstic acid (STA) in the cathode catalyst layer and/or in the cathode.

In general, the present disclosure provides for improved systems and methods for producing high activity materials, membranes and/or electrode assemblies (e.g., MEAs) for use in electrochemical devices, wherein the high activity membranes and/or electrode assemblies include at least one inorganic acid, and wherein the high activity membranes and/or electrode assemblies are functional at the higher temperature (e.g., about 118° C.), low RH (e.g., about 40% RH) and atmospheric pressure environment. In exemplary embodiments, the present disclosure provides for improved systems and methods for producing high activity membranes and/or electrode assemblies (e.g., MEAs) for use in electrochemical devices, wherein the high activity membranes and/or electrode assemblies include at least one inorganic acid in the catalyst layer and/or in the cathode, and wherein the high activity membranes and/or electrode assemblies are functional at the higher temperature (e.g., about 118° C.), low RH (e.g., 40% RH) and atmospheric pressure environment.

Current practice provides that electrochemical devices such as, for example, ion exchange membrane fuel cells or proton exchange membrane fuel cells (PEMFCs), often require effective catalysts associated with the membranes or materials to provide for reactivity with the fuel and oxidant sources and resulting products of catalysis. In general, current catalysts (e.g., various alloys of platinum, ruthenium and/or other precious metals) employed are expensive and/or complex, due in part, for example, to their complicated structure and their dependence on expensive rare metals. For example, one of the difficulties with current electrochemical devices or PEMFCs is the relatively high cost that is partially related to the cost of the cathode catalyst needed to catalyze the reaction at the cell cathode.

In general, the present disclosure provides for improved and cost effective systems and methods for producing materials, membranes, electrode assemblies (e.g., membrane electrode assemblies) and/or electrochemical devices (e.g., fuel cells, metal air batteries, ultra capacitors, etc.) employing the membranes and/or electrode assemblies. In exemplary embodiments, the present disclosure provides for improved systems and methods for producing high activity membranes and/or electrode assemblies (e.g., MEAs) for use in electrochemical devices, wherein the high activity membranes and/or electrode assemblies include at least one inorganic acid in the catalyst layer and/or in the cathode, thereby reducing higher-cost catalyst content (e.g., platinum), and therefore providing a significant manufacturing and commercial advantage as a result. In general, inorganic acids, such as, for example, heteropolyacids, are generally significantly cheaper than current catalysts (e.g., various alloys of platinum, ruthenium and/or other precious metals), and are typically easily handled with minimal safety concerns.

Current practice also provides that increased proton conductivity is desired for some electrochemical device or PEMFC applications, particularly for fuel cells or the like that operate at high current densities. For example, operation of PEMFCs at elevated temperature is typically limited by the electrolyte's dependence on water content, and the proton conductivity of current membranes or materials generally decreases with relative humidity. Current practice provides that operating a electrochemical device or fuel cell above the boiling point of water generally necessitates either pressurized operation at high relative humidities (RH), or lower RH operation at atmospheric pressure. However, commonly used membranes (e.g., Nafion®) or materials experience a significant loss in ionic conductivity at low RH conditions.

In exemplary embodiments, the present disclosure provides for improved systems and methods for producing high activity materials, membranes and/or electrode assemblies (e.g., MEAs) for use in electrochemical devices (e.g., fuel cells, metal air batteries, ultra capacitors, etc.), wherein the high activity membranes and/or electrode assemblies include at least one inorganic acid, and wherein the high activity membranes and/or electrode assemblies are functional and/or exhibit operational improvement at the higher temperature (e.g., about 118° C.), low RH (e.g., about 40% RH) and atmospheric pressure environment, thereby providing a significant manufacturing and commercial advantage as a result. For example, by operating a fuel cell or the like at higher temperatures and lower relative humidities, some advantages that may be experienced include, for example, more efficient heat rejection, improved impurities tolerance and more useful waste heat.

The present disclosure will be further described with respect to the following examples; however, the scope of the disclosure is not limited thereby. The following examples illustrate the process of the disclosure of producing high activity materials, membranes and/or electrode assemblies (e.g., MEAs) for use in electrochemical devices (e.g., fuel cells), wherein the high activity membranes and/or electrode assemblies include at least one inorganic acid, such as, for example, a heteropolyacid.

In exemplary embodiments and as depicted in Table 1 below, proton exchange membrane fuel cells were assembled (as discussed in Examples 1 and 2 below) and tested at about 78° C. with about 100% RH reactants, and tested at about 118° C. with about 40% RH reactants. For example and as tabulated in Table 1, 25cm² cells were prepared (as discussed in Examples 1 and 2 below) with platinum supported on carbon cathode catalysts (e.g., Pt/C) using 1100 EW Nafion® to evaluate, inter alia, the effects of the addition of inorganic proton conductors to the cathode (e.g., to evaluate the beneficial effects on the kinetics of the ORR). Some of these cells (using Nafion® 112 membranes) shown in Table 1 were evaluated as control cells with no additive (e.g., no STA added to the cathode). Other cells (using Nafion® 112 membranes) had silicotungstic acid (STA) added to the cathode via the “STA Catalyst Dip” approach or method (Example 1) or via the “STA Cathode Blend” approach or method (Example 2) discussed below.

TABLE 1

| | | | | | | | | Cell | Cell |
|---|---|---|---|---|---|---|---|---|---|
| | | | | | | | | Resistance | Resistance |
| | | | | | Cathode | Activity at | Activity at | at | at |
| | | | | Cathode | Catalyst | 78° C./100% | 118° C./40% | 78° C./100% | 118° C./40% |
| Cell | Membrane | Cathode | | Loading | Area | R.H. | R.H. | R.H. | R.H. |
| Number | Type | Electrolyte | STA | (mgPt/cm²) | (m²/g) | (mA/cm²) | (mA/cm²) | (Ωcm²) | (Ωcm²) |
| B430 | Nafion 112 | 32 wt % | — | 0.4 | | 20 | 8.1 | 0.08 | 0.29 |
| | | Nafion | | | | | | | |
| B602 | Nafion 112 | 32 wt % | — | 0.28 | 72.9 | 20 | 9 | 0.06 | 0.26 |
| | | Nafion | | | | | | | |
| B642 | Nafion 112 | 32 wt % | — | 0.417 | 61.7 | 42 | 15.1 | 0.054 | 0.232 |
| | | Nafion | | | | | | | |
| B637 | Nafion 112 | 32 wt % | Cathode | 0.42 | 62.4 | 28.8 | 17.4 | 0.057 | 0.236 |
| | | Nafion + 3% | Blend | | | | | | |
| | | STA | | | | | | | |
| B603 | Nafion 112 | 32 wt % | Cathode | 0.26 | 93.3 | 12 | 10 | 0.06 | 0.23 |
| | | Nafion + 6% | Blend | | | | | | |
| | | STA | | | | | | | |
| B604 | Nafion 112 | 32 wt % | Cathode | 0.26 | 42 | 15 | 11 | 0.07 | 0.25 |
| | | Nafion + 6% | Blend | | | | | | |
| | | STA | | | | | | | |
| B606 | Nafion 112 | 32 wt % | Cathode | 0.33 | 38.2 | 16 | 10 | 0.07 | 0.24 |
| | | Nafion + 6% | Blend | | | | | | |
| | | STA | | | | | | | |
| B632 | Nafion 112 | 32 wt % | Cathode | 0.38 | 67.3 | 23.4 | 17.7 | 0.055 | 0.236 |
| | | Nafion + 6% | Blend | | | | | | |
| | | STA | | | | | | | |
| B608 | Nafion 112 | 32 wt % | Cathode | 0.28 | 59.3 | 16 | 10 | 0.07 | 0.26 |
| | | Nafion + | Blend | | | | | | |
| | | 12% STA | | | | | | | |
| B630 | Nafion 112 | 32 wt % | Catalyst | 0.38 | 66.2 | 13.5 | 17.5 | 0.06 | 0.22 |
| | | Naf.. + 10% | Dip | | | | | | |
| | | STA/Pt/C | | | | | | | |
| B638 | Nafion 112 | 32 wt % | Catalyst | 0.353 | 59.4 | 14.4 | 16.4 | 0.056 | 0.23 |
| | | Naf. + 10% | Dip | | | | | | |
| | | STA/Pt/C | | | | | | | |
| B639 | Nafion 112 | 32 wt % | Catalyst | 0.38 | 64.9 | 23 | 20.5 | 0.058 | 0.248 |
| | | Naf. + 10% | Dip | | | | | | |
| | | CsSTA/Pt/C | | | | | | | |
| B641 | Nafion 112 | 28 wt % | Catalyst | 0.356 | 64.6 | 33.2 | 19.9 | 0.05 | 0.24 |
| | | Naf. + 10% | Dip | | | | | | |
| | | CsSTA/Pt/C | | | | | | | |

### EXAMPLE 1

In one approach or method (the “STA Catalyst Dip” or “Catalyst Dip” approach or method in Table 1 above), carbon cathode catalyst (Pt/C) was soaked in about a 10% (wt %) solution of silicotungstic acid (STA) in water. More particularly, commercial platinum on carbon (Pt/C, about 46.5 wt % Pt) cathode catalyst obtained from Tanaka Kikinzoku, Japan, was soaked in about a 10 wt % solution of silicotungstic acid (STA) in water overnight. It is noted that solutions of other inorganic acids other than STA, such as, for example, other heteropolyacids (e.g., phosphotungstic acid (PTA), etc.) may be used in lieu of STA.

The carbon cathode catalyst was then filtered and dried at about 140° C. for about one hour, with an additional half-hour at about 140° C. with applied vacuum. The dried catalyst was mixed with water, methanol and a dispersion of Nafion® 1100EW (an ion-exchange material) to form a cathode catalyst mixture or cathode electrolyte. More particularly, the dried catalyst (about 0.72 gm) was mixed with a small amount of water (about 3 gm), methanol (about 20 gm) and about a 5 wt % dispersion of Nafion® 1100EW (an ion-exchange material) from Solution Technologies, Inc. (about 5 gm) to form a cathode catalyst mixture. Alternatively, the dried catalyst may be mixed with other suitable ion-exchange materials, such as, for example, sulfonated polyetherether ketone (PEEK) or the like, to form a cathode catalyst mixture or cathode electrolyte. The catalyst may also be mixed with an ion-exchange material having an equivalent weight of about 600 to about 1000. The cathode catalyst mixture was homogenized with a homogenizer (e.g., an Omni International homogenizer) for about 6 hours.

The cathode catalyst mixture was then sprayed or applied onto membranes (e.g., Nafion® 112) or materials for application in electrochemical devices or fuel cells or the like. It is noted that the cathode catalyst mixture may be sprayed or applied onto other suitable materials (e.g., a material layer) for application in electrochemical devices or fuel cells or the like. One group of ion-exchange materials for fuel cells or PEM cells is perfluorinated sulfonic acid polymers such as, for example, Nafion®. Nafion® 112 membranes were used, although the present disclosure is not limited thereto. Other suitable ion-exchange materials for fuel cells or PEM cells include other polymer electrolytes, such as, for example, sulfonated polyetherether ketone (PEEK) or the like. The cathode catalyst mixture may also be sprayed or applied onto membranes having an equivalent weight of about 850 to about 1200. The cathode catalyst mixture may also be applied on or to the membrane or material by screen printing or the like, or by forming a cathode catalyst mixture decal that is transferred to the membrane or material.

After spraying or applying the cathode catalyst mixture onto the membranes or materials to form membranes/materials with electrodes or membrane electrode assemblies (“MEAs”), two of the electrode assemblies (e.g., the MEAs of cells B639 and B641 of Table 1) were immersed in a solution of cesium carbonate (Cs₂CO₃), hot-pressed at about 180° C., and then protonated. More particularly, two of the electrode assemblies (e.g., the MEAs of cells B639 and B641 of Table 1) were soaked in 0.1 N Cs₂CO₃ overnight, then hot pressed at about 180° C. and about 20 psi pressure. For example, the MEA was first submersed in a solution of cesium carbonate to convert the Nafion® and STA from the acid to the cesium forms. The treatment with cesium carbonate converted the STA into a water insoluble form, while also exchanging the protons in Nafion® with cesium atoms. In the cesium form, the membranes were then hot-pressed at about 180° C., and converted back to the acid form by soaking in sulfuric acid (H₂SO₄). This higher temperature (e.g., about 180° C.) was possible because the Nafion® was in the cesium form and may result in Nafion® flow and improved endurance. In general, the cesium form of the STA was found to retain some cesium during the protonation resulting in a material that is insoluble in water.

After protonating the MEA using sulfuric acid, the MEA was then washed and dried. More particularly, these two MEAs were subsequently soaked in 0.5 N H₂SO₄ at about 60° C. for about three (3) hours, followed by soaking in dH₂O at about 60° C. for about an hour, then drying at about 70° C. for about two hours.

In addition, another two of the MEAs fabricated from the “STA Catalyst Dip” or “Catalyst Dip” approach or method (e.g., the MEAs of B630 and B638 of Table 1) did not experience the cesium treatment (e.g., these MEAs were not immersed in a solution of cesium carbonate (Cs₂CO₃), were not later hot-pressed at about 180° C., and were not later protonated using sulfuric acid).

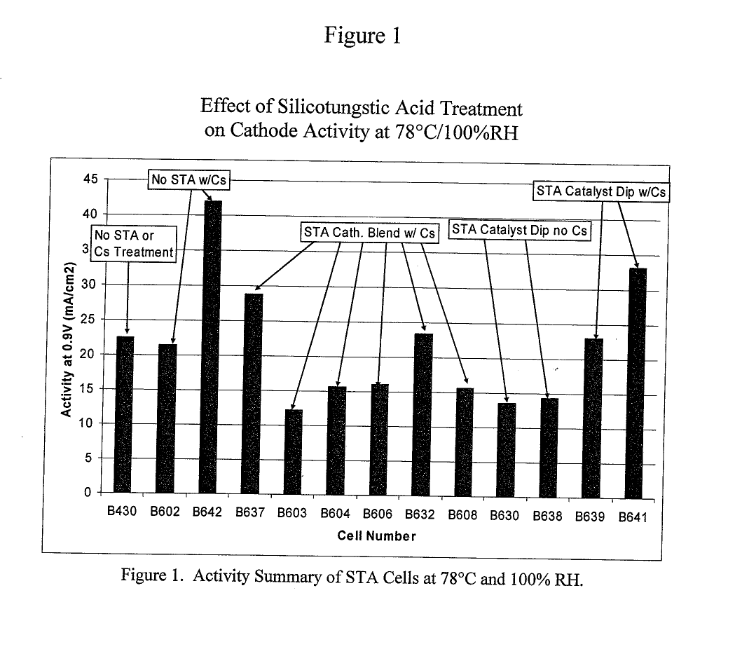

All four MEAs fabricated from the “STA Catalyst Dip” or “Catalyst Dip” approach or method (e.g., the MEAs of cells B630, B638, B639 and B641 of Table 1) were then assembled into fuel cell hardware with single serpentine flow fields and tested at about 78° C. and about 118° C. with H₂/Air and H₂/O₂. More particularly, these MEAs were assembled into 25 cm² cells and tested at various conditions with H₂/Air and H₂/O₂ reactants, as depicted in FIGS. 1-7, and as discussed below. As shown in Table 1, activity data was collected in the low current density region on H₂/O₂. The activity of the catalyst was determined by calculating the current at an IR-free cell voltage of about 0.9V with H₂/O₂ at both 78° C. and 118° C. The results are shown in Table 1.

As shown in Table 1, the resulting catalysts of cells B639 and B641 (both having their electrode assembly with catalyst soaked in STA solution and with cesium treatment) showed higher activity at elevated temperature and decreased relative humidity, as compared to the commercial precursor (e.g., control fuel cell [B642] having electrode assembly with no STA additive and with cesium treatment).

### EXAMPLE 2

In another approach or method (the “STA Cathode Blend” or “Cathode Blend” approach or method in Table 1), the cathode catalyst (Pt/C), dissolved STA (e.g., about 3 wt % STA, about 6 wt % STA, or about 12 wt % STA), and Nafion® solution (e.g., dispersion of Nafion® 1100EW) were blended or mixed to form a cathode catalyst mixture or cathode electrolyte, which was then applied to the membrane (e.g., Nafion® 112). For example, the dissolved STA was added to a slurry of Pt/C catalysts and the Nafion® solution to form a cathode catalyst mixture or cathode electrolyte. The dissolved STA and catalyst slurry may also be mixed with an ion-exchange material having an equivalent weight of about 600 to about 1000 to form a cathode catalyst mixture.

After blending or mixing, this mixture was then sprayed or applied onto the membrane (e.g., Nafion®) 112) to form membranes with electrodes or membrane electrode assemblies (“MEAs”). It is noted that the cathode catalyst mixture may be sprayed or applied onto other suitable materials (e.g., a material layer) for application in electrochemical devices or fuel cells or the like. The cathode catalyst mixture or cathode electrolyte may also be applied on the membrane or material by screen printing or the like, or by forming a cathode catalyst mixture decal that is transferred to the membrane or material. Nafion® 112 membranes were used, although the present disclosure is not limited thereto. The cathode catalyst mixture may also be sprayed or applied onto membranes having an equivalent weight of about 850 to about 1200.

In this approach, the MEA or electrode assembly was immersed in a solution of cesium carbonate (Cs₂CO₃), hot-pressed at about 180° C., and then protonated. For example, the MEA was first submersed in a solution of cesium carbonate to convert the Nafion® and STA from the acid to the cesium forms. The treatment with cesium carbonate converted the STA into a water insoluble form, while also exchanging the protons in Nafion® with cesium atoms. In the cesium form, the membranes were then hot-pressed at about 180° C., and converted back to the acid form by soaking in sulfuric acid (H₂SO₄). This higher temperature (e.g., about 180° C.) was possible because the Nafion® was in the cesium form and may result in Nafion® flow and improved endurance. In general, the cesium form of the STA was found to retain some cesium during the protonation resulting in a material that is insoluble in water. After protonating the MEA using sulfuric acid, the MEA was then washed and dried. Completed MEAs from this “STA Cathode Blend” or “Cathode Blend” approach were assembled into 25 cm² cells and tested at various conditions with H₂/Air and H₂/O₂ reactants, as depicted in FIGS. 1-7 (discussed below). As shown in Table 1, activity data was collected in the low current density region on H₂/O₂.

### DISCUSSION OF EXAMPLES 1 AND 2

### Cathode Catalytic Activity Improvement

As shown in Table 1, the above-mentioned cells containing the MEAs fabricated from the STA Cathode Blend or Cathode Blend approach or method and the cells containing the MEAs from the STA Catalyst Dip or Catalyst Dip approach or method were tested using hydrogen/air and hydrogen/oxygen reactants at the conditions of about 78° C., 100% relative humidity, and at the conditions of about 118° C., 40% RH. In addition, some of the cells (using Nafion® 112 membranes) shown in Table 1 were evaluated as control cells with no additive (e.g., no STA added to the cathode). The activity was determined from the oxygen data by determining the current at about 0.9 V IR-free cell voltage, as displayed in Table 1.

FIG. 1 shows a summary of the activity at about 78° C. The activity can be seen to be quite variable with several of the STA treated cells having lower activity. Cells B602 and B642 were prepared using the cesium treatment but with no STA to provide a baseline. Considerable difference in activity resulted. An older, acceptable-performing Nafion® 112 cell (B430) with no cesium treatment provided performance similar to B602. The cells in the center group were ones with the blended STA, cathode catalyst, Nafion® approach (“STA Cathode Blend”) and experienced the cesium treatment. In general, the blended or mixed STA content was varied in an attempt to optimize the STA content. A clear trend was not initially found, but the 3 wt % STA (cell B637) and one 6 wt % STA case (cell B632) resulted in activity above the baseline cell B602. As shown in FIG. 1, both of the catalyst-coated cells (“STA Catalyst Dip”) without the cesium treatment (B630 and B638) resulted in lower activity, but the cells with the cesium treatment (B639 and B641) resulted in values above that of the baseline cell B602.

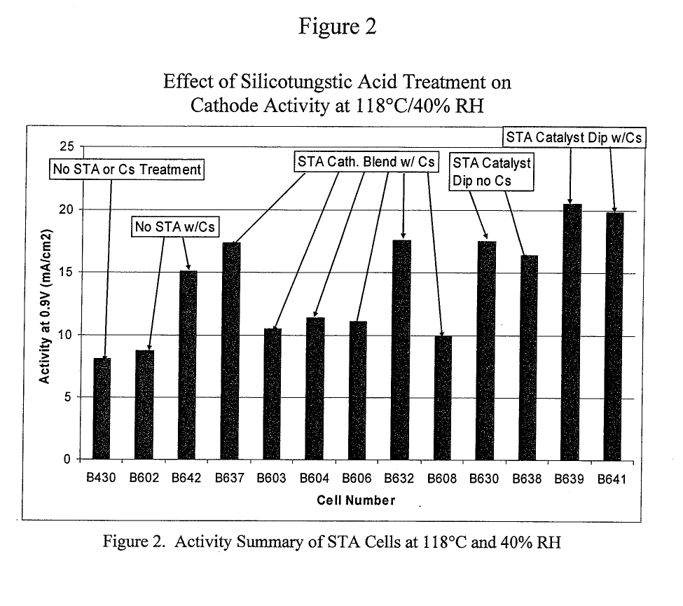

As shown in FIG. 2, the activity results are different for the 118° C., 40% relative humidity case. As depicted in FIG. 2, two of the cells (B637 and B632) with the STA added to the cathode catalyst blend (STA Cathode Blend) and all four of the cells with the STA-coated cathode catalyst (STA Catalyst Dip) resulted in higher activity than both baseline cells B602 and B642. For the catalyst-coated cell (STA Catalyst Dip), the conversion of the STA to the cesium salt form did not harm the activity.

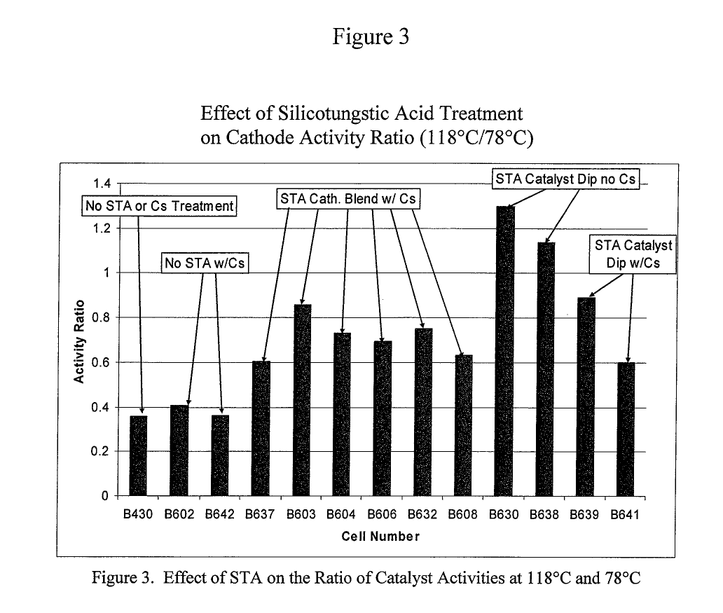

Because the activity at 78° C. showed such variability, structural differences in the cathode were suspected. Therefore the ratio of activities at the 78° C. and 118° C. cases were plotted, as shown in FIG. 3. In FIG. 3, the beneficial effect of STA in increasing the activity at the higher temperature can be clearly seen. All of the STA treated cells resulted in a higher ratio than all of the cells not containing STA.

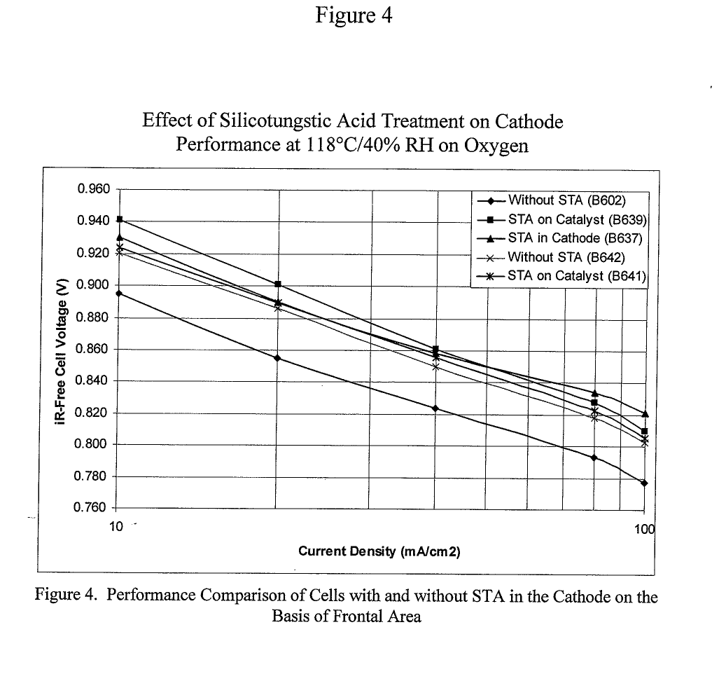

In order to demonstrate the actual performance improvement, the IR-free performance data on hydrogen/air reactants at the 118° C. condition were plotted for the case with no STA in the cathode, and cases where the STA was added to the catalyst (STA Catalyst Dip) and added to the cathode blend (STA Cathode Blend). This data can be seen in FIG. 4. A factor of about 1.5 to about 2 increase in current density results, which indicates that a factor of about 1.5 to about 2 reduction of platinum or the like loading may be possible with no performance loss. A reduction in platinum or the like content in fuel cells or electrochemical cells would significantly reduce the cost and complexity of the fuel cells or electrochemical cells, thereby providing a significant commercial advantage as a result.

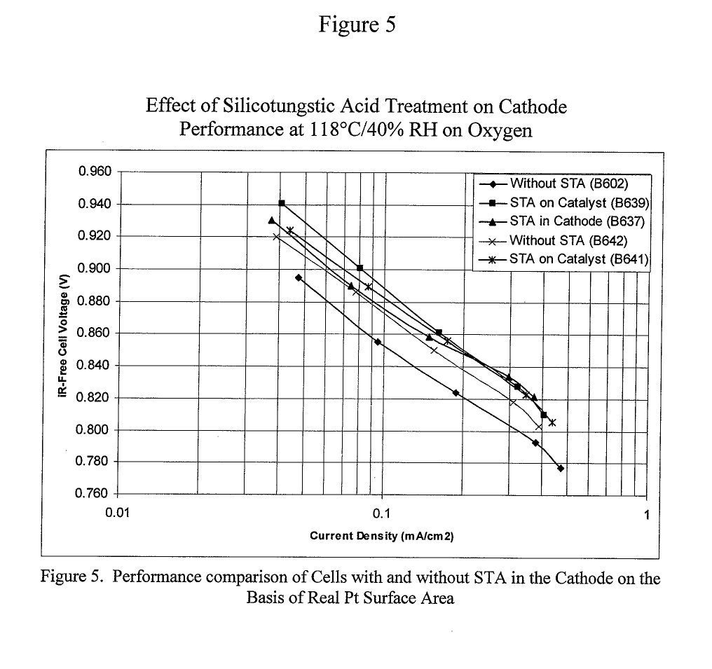

Since cyclic voltammetry was performed on each cathode, a performance comparison could also be made on the basis of IR-free cell voltage versus current per unit of real catalyst surface area. This comparison is shown in FIG. 5. As shown in FIG. 5, the STA results in a significant enhancement in performance. The catalyst areas are listed in Table 1.

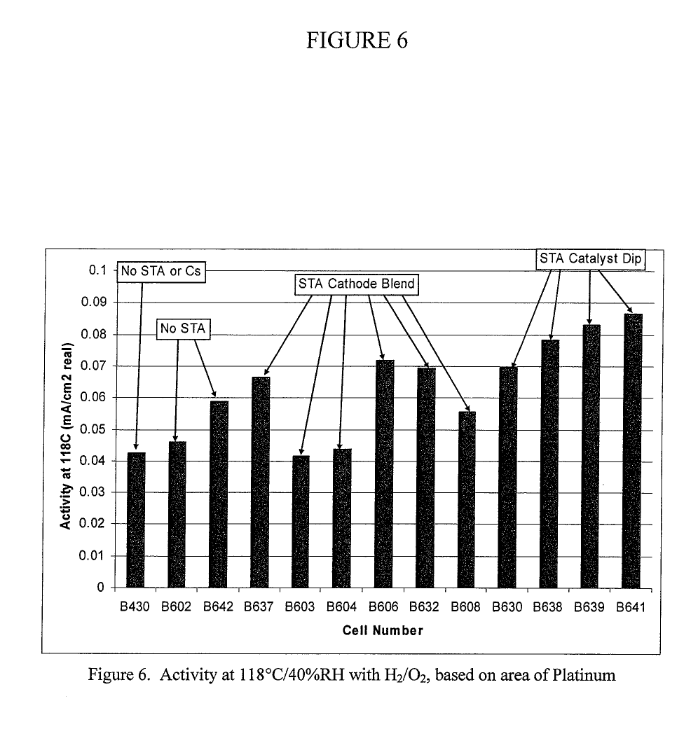

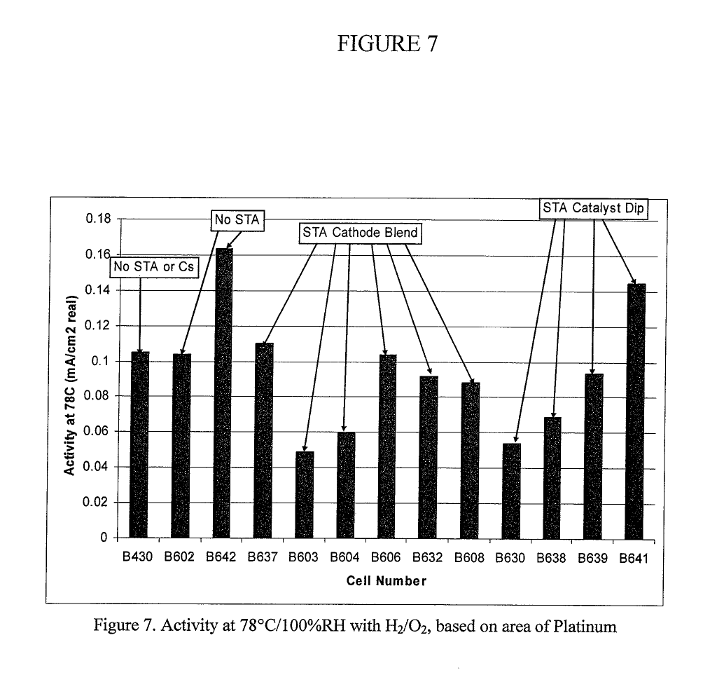

A significantly increased activity for the oxygen reduction reaction (ORR) on the basis of real surface area was observed when the cells with the STA additive were tested at about 118° C. and about 40% relative humidity. FIG. 6 shows the activities measured on oxygen at this condition. As shown in FIG. 6, the three cells on the left (B430, B602 and B642) were constructed or fabricated without the additive, whereas all of the other cells contained a proton-conducting additive (e.g., STA). As shown in FIG. 6, about a 45% increase in the activity was obtained. Care was taken to obtain high performance from the cells without the additive so any activity improvement could be attributed to the additive. As shown in FIG. 7, those cells (B430, B602 and B642) performed at lower temperature (e.g., about 78° C.) and 100% relative humidity with catalytic activities similar to those reported (e.g., 66 to 77 μA/cm² real) by H. A. Gasteiger, et al., in Applied Catalysis B: Environment 68, pp. 8-36 (2006). In general, the Gasteiger data was obtained using 900 equivalent weight (EW) perfluorosulfonic acid in the cathode. Therefore, this lower EW would be expected to improve activity.

As shown in Table 1 and FIG. 6, addition of STA to the electrode significantly improved the cathode oxygen reduction activity at 0.9V and 118° C. from 15.1 mA/cm² up to 20.5 mA/cm². Without being bound by theory, this implies that since STA has been shown to enhance membrane or material conductivity, proton mobility is likely improved. In addition, the kinetic activity of the proton might also be increased, resulting in enhanced oxygen reduction kinetics.

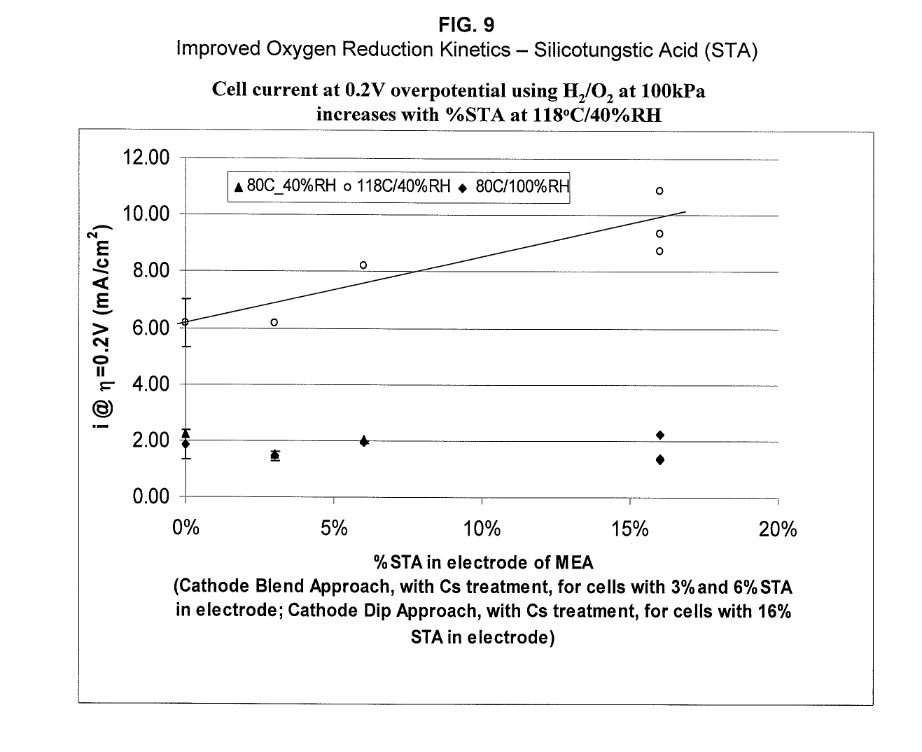

In addition, FIG. 9 shows that, when tested at about 118° C. with about 40% RH reactants, the cell current (at about 0.2V overpotential using H₂/O₂ reactants at about 100 kPa) of exemplary fuel cells having STA in their electrodes increased with increased percent (wt %) STA in the cathode catalyst mixture or cathode electrolyte of the MEAs. The exemplary fuel cells tested in FIG. 9 which included about 3% and about 6% STA in the electrodes utilized MEAs fabricated from the “STA Cathode Blend” or “Cathode Blend” approach discussed above (except for the control cell with 0% STA in the electrode), and each exemplary fuel cell experienced the cesium treatment as discussed above. In addition, the exemplary fuel cell tested in FIG. 9 which included about 16% STA in the electrode utilized an MEA fabricated from the “STA Catalyst Dip” or “Catalyst Dip” approach or method discussed above, and this exemplary fuel cell also experienced the cesium treatment as discussed above.

After forming the MEAs, fuel cells were assembled and tested at about 118° C. with about 40% RH reactants, as displayed in FIG. 9. As noted, when tested at the higher temperature (e.g., about 118° C.) and low RH (e.g., about 40% RH) environment, the cell current (at about 0.2V overpotential using H₂/O₂ reactants at about 100 kPa) of these fuel cells increased with increased percent (wt %) STA in the cathode catalyst mixture of the MEAs.

### EXAMPLE 3

The impact of STA loading in the membrane or material on conductivity at high temperature (e.g., about 118° C.) and low relative humidity (e.g., about 40% RH) was investigated. In exemplary embodiments, membranes or materials were manufactured using Nafion® 1100 EW and STA supported in a porous polytetrafluoroethylene (PTFE) film (e.g., a porous polymeric matrix material). Polytetrafluoroethylene (PTFE) is an example of a suitable porous polymeric matrix material. The membranes may also be fabricated from: (i) an ion-exchange material having an equivalent weight of about 850 to about 1200, and (ii) an inorganic acid, such as, for example, STA; with the ion-exchange material and the inorganic acid being supported in a porous polymeric matrix material.

Electrodes composed of the same Nafion® and Tanaka 46.5% Pt/C catalyst were sprayed onto both sides of the membranes to produce membrane-electrode assemblies (MEAs). The electrodes may also be composed of: (i) an ion-exchange material having an equivalent weight of about 600 to about 1000, and (ii) a cathode catalyst, such as, for example, 46.5% Pt/C catalyst.

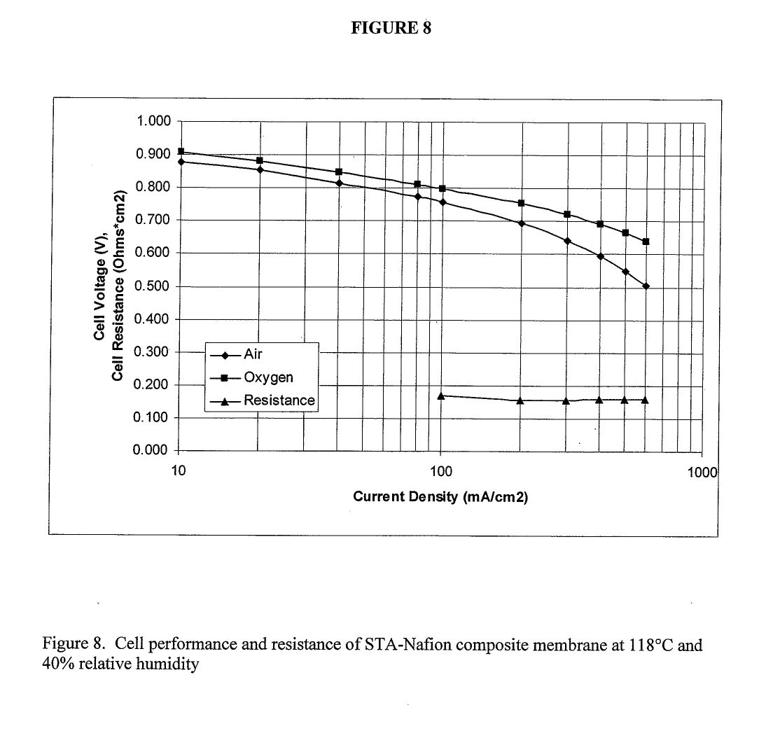

After electrode application, treatment with Cs₂CO₃ (e.g., immersion in a solution of cesium carbonate (Cs₂CO₃), as discussed above) converted the STA into a water insoluble form, while also exchanging the protons in Nafion® with cesium atoms. In the cesium form, the membranes or materials were hot-pressed at about 180° C., and converted back to the acid form by soaking in sulfuric acid (e.g., as discussed above in Examples 1 and 2). Completed MEAs were assembled into 25 cm² cells and tested at various conditions with H₂/Air and H₂/O₂ reactants. Membrane conductivity data was collected using the current-interrupt method. Performance and resistance data for such a composite membrane with STA at about 118° C. and about 40% relative humidity is shown in FIG. 8.

As shown in FIG. 8, the membrane with STA resulted in low membrane resistance of 0.17 Ωcm at 118° C. and 40% relative humidity. Also, adding STA to the membrane improved the cathode oxygen reduction activity at 0.9V and 118° C. from 12.6 mA/cm² up to 16.8 m A/cm². Low relative humidity may lead to a reduced rate of the oxygen reduction reaction, presumably due partially to a reduced kinetic proton activity. Increasing the proton activity by reducing the equivalent weight of the electrolyte has resulted in an improvement in catalytic activity. Without being bound by theory, this implies that modification of the membrane to improve proton mobility could have effects in the electrode, as shown in FIG. 8 and discussed above.

In an alternative embodiment of the present disclosure, the membranes or materials may be manufactured using, for example, Nafion® 1100 EW (or an ion-exchange material having an equivalent weight of about 850 to about 1200) supported in a porous polymeric matrix material (e.g., PTFE).

Electrodes may then be sprayed or applied onto both sides of the manufactured membranes to produce membrane-electrode assemblies. For example, the electrodes may be composed of the same Nafion® and Tanaka 46.5% Pt/C catalyst. The electrodes may also be composed of: (i) an ion-exchange material having an equivalent weight of about 600 to about 1000, and (ii) a cathode catalyst, such as, for example, a Pt/C catalyst.

After electrode application, the MEAs may then be soaked in an inorganic acid, such as, for example, a heteropolyacid (e.g., STA, phosphotungstic acid (PTA), etc.). For example, the MEAs may be soaked in about 0.5 g/ml PTA or STA, and then dried. Alternatively, the MEAs may be soaked in about a 10 wt % solution of inorganic acid. After soaking in the inorganic acid, the MEAs may be treated with Cs₂CO₃ as discussed above to convert the inorganic acid into a water insoluble form, and to exchange the protons in Nafion® with cesium atoms. In the cesium form, the membranes may then be hot-pressed (e.g., at 180° C.), and converted back to the acid form by soaking in sulfuric acid, as discussed above. The completed MEAs may then be assembled into cells for testing. In this way, an inorganic acid, such as, for example, a heteropolyacid (e.g., STA, phosphotungstic acid (PTA), etc.) may be added to the cathode catalyst layer of a membrane in a PEM fuel cell or fuel cell or the like to increase the performance of the fuel cell or the like. For example, by adding a heteropolyacid such as, for example, PTA or STA, to the cathode side, more hydrogen ions are added, increasing the rate of reaction.

Although the systems and methods of the present disclosure have been described with reference to exemplary embodiments thereof, the present disclosure is not limited to such exemplary embodiments and/or implementations. Rather, the systems and methods of the present disclosure are susceptible to many implementations and applications, as will be readily apparent to persons skilled in the art from the disclosure hereof. The present disclosure expressly encompasses such modifications, enhancements and/or variations of the disclosed embodiments. Since many changes could be made in the above construction and many widely different embodiments of this disclosure could be made without departing from the scope thereof, it is intended that all matter contained in the drawings and specification shall be interpreted as illustrative and not in a limiting sense. Additional modifications, changes, and substitutions are intended in the foregoing disclosure. Accordingly, it is appropriate that the claims be construed broadly and in a manner consistent with the scope of the disclosure.

What is claimed is:

1. A method for fabricating an electrode assembly comprising:
a) soaking a cathode catalyst in an inorganic acid;
b) drying the cathode catalyst after soaking;
c) mixing the cathode catalyst with an ion-exchange material to form a cathode catalyst mixture;
d) applying the cathode catalyst mixture on a membrane or material layer.

2. The method of claim 1, wherein the cathode catalyst is a platinum on carbon cathode catalyst.

3. The method of claim 2, wherein the cathode catalyst is about 46.5 wt % platinum.

4. The method of claim 1, wherein the inorganic acid is a heteropolyacid.

5. The method of claim 1, wherein the inorganic acid is selected from the group consisting of silicotungstic acid (STA), phosphotungstic acid (PTA), tungstomolybdic acid, zirconium hydrogen phosphate, phosphomolybdic acid (PMA) and combinations thereof.

6. The method of claim 1, wherein the ion-exchange material is a polymer electrolyte.

7. The method of claim 1, wherein the ion-exchange material is a perfluorinated sulfonic acid polymer or sulfonated polyetherether ketone polymer.

8. The method of claim 1, wherein step a) is performed by soaking the cathode catalyst in about a 10 wt % solution of inorganic acid.

9. The method of claim 8, wherein the inorganic acid is a heteropolyacid.

10. The method of claim 1, wherein step b) is performed by drying the cathode catalyst at about 140° C. for about one hour.

11. The method of claim 1, wherein step c) further comprises mixing water and methanol with the cathode catalyst and the ion-exchange material to form the cathode catalyst mixture.

12. The method of claim 1, wherein the catalyst mixture of step c) is homogenized with a homogenizer prior to step d).

13. The method of claim 1, wherein the cathode catalyst mixture is applied on the membrane or material layer by spraying, screen printing, or by forming a cathode catalyst mixture decal that is transferred to the membrane or material layer.

14. The method of claim 1, wherein the membrane or material layer is a proton exchange membrane.

15. The method of claim 1, further comprising the steps of:
e) converting the ion-exchange material and inorganic acid to cesium form;
f) hot-pressing the membrane or material layer; and
g) protonating the membrane or material layer to convert the ion-exchange material and inorganic acid to acid form;
wherein steps e), f), and g) are performed after step d).

16. The method of claim 15, wherein step e) is performed by soaking the membrane or material layer in cesium carbonate.

17. The method of claim 15, wherein step f) is performed by hot-pressing the membrane or material layer at about 180° C. and about 20 psi pressure.

18. The method of claim 15, wherein step g) is performed by soaking the membrane or material layer in sulfuric acid.

19. The method of claim 1, wherein the ion-exchange material has an equivalent weight of about 600 to about 1000, and wherein the membrane or material layer has an equivalent weight of about 850 to about 1200.

20. A method for fabricating an electrode assembly comprising:
a) mixing a cathode catalyst, an inorganic acid and an ion-exchange material to form a cathode catalyst mixture; and
b) applying the cathode catalyst mixture on a membrane or material layer.

21. The method of claim 20, wherein the cathode catalyst is a platinum on carbon cathode catalyst.

22. The method of claim 21, wherein the cathode catalyst is about 46.5 wt % platinum.

23. The method of claim 20, wherein the inorganic acid is a heteropolyacid.

24. The method of claim 20, wherein the inorganic acid is selected from the group consisting of silicotungstic acid (STA), phosphotungstic acid (PTA), tungstomolybdic acid, zirconium hydrogen phosphate, phosphomolybdic acid (PMA) and combinations thereof.

25. The method of claim 20, wherein the ion-exchange material is a polymer electrolyte.

26. The method of claim 20, wherein the ion-exchange material is a perfluorinated sulfonic acid polymer or sulfonated polyetherether ketone polymer.

27. The method of claim 20, wherein the cathode catalyst mixture is applied on the membrane or material layer by spraying, screen printing, or by forming a cathode catalyst mixture decal that is transferred to the membrane or material layer.

28. The method of claim 20, wherein the membrane or material layer is a proton exchange membrane.

29. The method of claim 20, further comprising the steps of:
c) converting the ion-exchange material and inorganic acid to cesium form;
d) hot-pressing the membrane or material layer; and
e) protonating the membrane or material layer to convert the ion-exchange material and inorganic acid to acid form;
wherein steps c), d), and e) are performed after step b).

30. The method of claim 29, wherein step c) is performed by soaking the membrane or material layer in cesium carbonate.

31. The method of claim 29, wherein step d) is performed by hot-pressing the membrane or material layer at about 180° C. and about 20 psi pressure.

32. The method of claim 29, wherein step e) is performed by soaking the membrane or material layer in sulfuric acid.

33. The method of claim 20, wherein the ion-exchange material has an equivalent weight of about 600 to about 1000, and wherein the membrane or material layer has an equivalent weight of about 850 to about 1200.

34. A method for fabricating an electrode assembly comprising:
a) supporting a first ion-exchange material and an inorganic acid in a porous polymeric matrix material to form a membrane or material layer;
b) applying electrodes to the membrane or material layer;
c) converting the first ion-exchange material and inorganic acid to cesium form;
d) hot-pressing the membrane or material layer;
e) protonating the membrane or material layer to convert the first ion-exchange material and inorganic acid to acid form.

35. The method of claim 34, wherein the first ion-exchange material is a polymer electrolyte.

36. The method of claim 34, wherein the first ion-exchange material is a perfluorinated sulfonic acid polymer or sulfonated polyetherether ketone polymer.

37. The method of claim 34, wherein the inorganic acid is a heteropolyacid.

38. The method of claim 34, wherein the inorganic acid is selected from the group consisting of silicotungstic acid (STA), phosphotungstic acid (PTA), tungstomolybdic acid, zirconium hydrogen phosphate, phosphomolybdic acid (PMA) and combinations thereof.

39. The method of claim 34, wherein the porous polymeric matrix material is polytetrafluoroethylene (PTFE).

40. The method of claim 34, wherein the electrodes are applied to the membrane or material layer by spraying, screen printing, or by forming a decal that is transferred to the membrane or material layer.

41. The method of claim 34, wherein step c) is performed by soaking the membrane or material layer in cesium carbonate.

42. The method of claim 34, wherein step d) is performed by hot-pressing the membrane or material layer at about 180° C. and about 20 psi pressure.

43. The method of claim 34, wherein step e) is performed by soaking the membrane or material layer in sulfuric acid.

44. The method of claim 34, wherein the first ion-exchange material has an equivalent weight of about 850 to about 1200, and wherein the electrodes include a second ion-exchange material having an equivalent weight of about 600 to about 1000.

45. A method for fabricating an electrode assembly comprising:
a) supporting a first ion-exchange material in a porous polymeric matrix material to form a membrane or material layer;
b) applying electrodes to the membrane or material layer;
c) soaking the membrane or material layer in an inorganic acid;
d) converting the first ion-exchange material and inorganic acid to cesium form;
e) hot-pressing the membrane or material layer;
f) protonating the membrane or material layer to convert the first ion-exchange material and inorganic acid to acid form.

46. The method of claim 45, wherein the first ion-exchange material is a polymer electrolyte.

47. The method of claim 45, wherein the first ion-exchange material is a perfluorinated sulfonic acid polymer or sulfonated polyetherether ketone polymer.

48. The method of claim 45, wherein the inorganic acid is a heteropolyacid.

49. The method of claim 45, wherein the inorganic acid is selected from the group consisting of silicotungstic acid (STA), phosphotungstic acid (PTA), tungstomolybdic acid, zirconium hydrogen phosphate, phosphomolybdic acid (PMA) and combinations thereof.

50. The method of claim 45, wherein the porous polymeric matrix material is polytetrafluoroethylene (PTFE).

51. The method of claim 45, wherein the electrodes are applied to the membrane or material layer by spraying, screen printing, or by forming a decal that is transferred to the membrane or material layer.

52. The method of claim 45, wherein step c) is performed by soaking the membrane or material layer in about a 10 wt % solution of inorganic acid.

53. The method of claim 45, wherein step d) is performed by soaking the membrane or material layer in cesium carbonate.

54. The method of claim 45, wherein step e) is performed by hot-pressing the membrane or material layer at about 180° C. and about 20 psi pressure.

55. The method of claim 45, wherein step f) is performed by soaking the membrane or material layer in sulfuric acid.

56. The method of claim 45, wherein the first ion-exchange material has an equivalent weight of about 850 to about 1200, and wherein the electrodes include a second ion-exchange material having an equivalent weight of about 600 to about 1000.
